(19) United States
(12) Patent Application Publication
(10) Pub. No.: US 2007/0297864 A1
(43) Pub. Date: Dec. 27, 2007

(54) Fluted Rotary Cutting Tool

(75) Inventor: Gary de Boer, Brampton (CA)

Correspondence Address: HODGSON RUSS LLP;THE GUARANTY BUILDING, 140 PEARL STREET, SUITE 100, BUFFALO, NY, 14202-4040, US

(73) Assignee: DE BOER TOOLS INC., Mississauga (CA)

(21) Appl. No.: 11/763,713

(22) Filed: Jun. 15, 2007

Related U.S. Application Data
(60) Provisional application No. 60/805,608, filed on Jun. 23, 2006.

(51) Int. Cl. B23C 5/02

(52) U.S. Cl. 407/54

(57) ABSTRACT

A rotary cutting tool comprises a shank extending along an axis of rotation of the cutting tool and a fluted portion adjacent the shank, the fluted portion having an effective flute length and a plurality of peripheral cutting edges indexed about the axis of rotation. At least one of the plurality of peripheral cutting edges is formed such that a two-dimensional representation of the peripheral cutting edge in schematic development view follows a quadratic curve over the effective flute length.

### FIELD OF THE INVENTION

This invention relates generally to rotary cutting tools for milling operations, and in particular to fluted end mills having a plurality of peripheral cutting edges.

### BACKGROUND OF THE INVENTION

In conventional rotary cutting tools, the peripheral cutting edges are designed to be equally spaced in order to allow even loading on the tool body as a whole. For this reason, the flutes of conventional cutting tools are of the same size and shape which allows equal load distribution among the cutting edges.

In general, rotary cutting tools are designed with multiple flutes spaced symmetrically around the circumference of the tool where the flutes run along a partial length of the tool ending at the tool shank. The tool shank is the portion of the tool that is mounted in a machine tool and the fluted portion is the portion of the tool that engages the workpiece. The total number of flutes may vary, and the flutes may be formed to extend either parallel to the longitudinal rotational axis of the tool or more commonly to extend about the rotational axis as a helix. In a helical arrangement, the cutting edges defined by the flutes are each described by a “helix angle,” which is the angle formed by a line tangent to the helix and a line parallel to the rotational axis of the tool.

Conventional rotary cutting tools perform adequately at conventional speeds (RPM) and feeds, however, at speeds and feeds higher than conventional, which is desirable for productivity, considerable performance decay is experienced. This performance decay is directly attributable to the presence and magnitude of vibration, specifically resonant vibration, as cutting force increases. At increased speeds and feeds, conventional helical and straight-fluted tools induce resonance, whereby the action of the tool cutting a workpiece has a tendency to enhance potential oscillatory energy when the frequency of the oscillations matches the system's natural frequency of vibration (its resonant frequency) or a harmonic thereof. The occurrence of uncontrolled resonant vibration inevitably results in a condition commonly referred to as “chatter,” which results in poor tool performance both in terms of life expectancy and workpiece quality. This is an undesirable occurrence.

Several approaches to solving the problem of chatter attempt to minimize the occurrence and resultant effect of resonant frequency vibration. This is generally accomplished by creating an irregular form on or in the leading edge of the flutes thereby interrupting the tendency of the system to create an uncontrolled oscillation. Additionally, these approaches may also include an asymmetrical arrangement of the flutes around the periphery (circumferential index) of the tool in order to further interrupt resonant frequency vibration. The ultimate goal of this activity is to prolong tool life by limiting the destructive characteristics of vibration at higher than conventional speeds and feeds.

The primary limiting factor of tools being made with an interrupting variable such as irregular flute form and/or irregular radial position is that the helical path that defines any of the peripheral cutting edges around the circumference is in fact a straight line segment or combination of straight line segments when the helical path is unrolled into a two-dimensional plane. Each line segment is described by a start point (x, y), an end point (x, y), and a slope (m) determined by the helix angle. Variations of the helical fluted tool that employ interrupting variables inherently contain, to various degrees, the same limitations as normally helixed/fluted tools.

The prior art includes numerous rotary cutting tool embodiments. For example, U.S. Pat. No. 4,963,059 discloses a rotary cutting tool having a plurality of helical peripheral cutting edges wherein at least one of the peripheral cutting edges has a helix angle different from helix angles of the other peripheral cutting edges, but two of the peripheral cutting edges share the same helix angle and are symmetrical with respect to the rotational axis of the tool. The cutting edges are spaced about the rotational axis at a regular circumferential index (equal angular spacing) in at least one plane disposed perpendicularly to the axis of rotation of the tool. This patent further discloses embodiments wherein a given cutting edge has two helical portions characterized by different helix angles, as shown in FIGS. 26-28.

U.S. Pat. No. 5,810,517 discloses a cutting tool having three complexly configured, equally spaced cutting edges that do not wrap around the rotational axis of the tool. In one embodiment, the cutting edges are defined by the intersections of right circular cylinders, offset from the rotational axis of the tool, with the frustum of a cone. In another embodiment, the tool includes a circumferentially, concavely radiused edge defining a quarter section of a torus disposed coaxially about the rotational axis and the cutting edges are defined by the intersection of the flutes. A third embodiment is similar to the first embodiment, except the oblique conical surfaces converge to a vertex. In all three embodiments, it is further disclosed, the cutting edge is a complex arcuate or crescent-shaped curve.

U.S. Pat. No. 5,984,592 shows a rotary cutting tool having a plurality of cutting inserts and containing at least one side insert with a cutting edge projected radically from the peripheral region of the tool body and at least one end insert projected from a forward axial end portion of the tool. These two inserts, it is disclosed, are located in positions that are angularly spaced about a central rotary axis of the tool and describe cutting envelopes that intersect or overlap in the rotation of the tool about said axis. It further teaches that each side insert is secured by clamping screws substantially radially into the tool body and at least two of these inserts are preferably symmetrically spaced about the central cutting axis of the tool body and in corresponding axial and radial positions.

U.S. Pat. Nos. 6,007,276 and 6,179,528 teach end mill tools including compound helical cutting edges characterized by a leading cutting edge portion defined by a relatively low helix angle and a trailing cutting edge portion defined by a relatively high helix angle.

U.S. Pat. No. 6,065,905 discloses a rotary cutting tool that includes a coating on its radial relief surfaces in order to enhance damping of vibratory motion of the tool at speeds which permit the relief surfaces to rub on the workpiece.

U.S. Pat. No. 6,132,146 teaches a rotary cutting tool with a longitudinal axis of rotation, having a cutting head formed with at least two chip evacuation flutes and at least two body portions bearing cutting inserts therebetween. It also discloses that the operative cutting edge of the second outer cutting insert is substantially shorter than the operative cutting edge of the first outer cutting insert and their outermost ends are substantially equidistant from the axis of rotation.

U.S. Pat. No. 6,152,657 discloses a helically-fluted ball nose or plunging end mill wherein a diamond-like material is exposed to form a cutting edge along the leading edge of the material extending sufficiently close to the center of the end mill for cutting the workpiece all the way to the center of the end mill.

U.S. Pat. No. 6,382,888 teaches use of a vibration dampened spindle and tool holder assembly for a rotary cutting machine, such tool holder having an interfacing ledge with a top surface for abutment with a distal spindle surface and a continuous channel disposed in a proximal portion of the top surface. It further discloses that a resilient dampening member, preferably fabricated from a natural or synthetic rubber composition and having a rectangular or a circular cross-sectional configuration, resides in the channel for compressed abutment with the spindle surface.

U.S. Pat. No. 6,991,409 describes rotary cutting tool embodiments including compound helical cutting edges wherein the helix angle is increased in steps along the axial direction from the cutting end of the tool toward the shank. In this regard, see FIGS. 8 and 24 of the '409 patent. The cutting edges are different from one another and are spaced unequally about the rotational axis of the tool to provide an irregular circumferential index.

U.S. Pat. No. 7,001,113 describes end mills including flutes and cutting edges having a helix angle that varies in a direction along the rotational axis of the tool. The helix angle may increase or decrease along this direction, the cutting edges may have different variations in helix angle, and circumferential indexing of the cutting edges may be irregular.

U.S. Patent Application Publication No. 2002/0090273 A1 discloses a rotary tool having roughing and finishing cutting edges on the same tool. In some embodiments, the blades are unequally spaced about the circumference of the tool body to help reduce tool harmonic vibrations.

The problems associated with resonant vibrations have not been satisfactorily solved by the prior art. Such vibrations, along with associated heat and wear, are detrimental to a long tool life. While new coating technologies have successfully addressed the issues of heat and wear by introducing a variety of metal, ceramic and chemical substrates, the concern involving resonant vibrations has not been eliminated by the prior art.

### SUMMARY OF THE INVENTION

It is an object of the present invention to provide a rotary cutting tool designed to interrupt generation of resonant frequency vibrations that cause tool chatter.

It is another object of the present invention to increase tool life.

It is a further object of the present invention to improve workpiece quality.

In pursuit of these and other objects, a rotary cutting tool is described which comprises a shank extending along an axis of rotation of the cutting tool and a fluted portion adjacent the shank, the fluted portion having an effective flute length and a plurality of peripheral cutting edges indexed about the axis of rotation. In accordance with the present invention, at least one and preferably each of the plurality of peripheral cutting edges is formed such that a two-dimensional representation of the peripheral cutting edge in schematic development view follows a quadratic curve over the effective flute length.

The quadratic curve may be a parabolic, circular, ellipsoidal, hyperbolic, or other quadratic curve, including a compound quadratic curve made up of differing quadratic curve portions. The curvature of a given quadratic curve or curve portion associated with a cutting edge is adjusted by altering the magnitude and sign (positive or negative) of a scaling constant of the quadratic curve or curve portion. In this way, some or all of the peripheral cutting edges may be formed differently from others so as to interrupt generation of resonant vibrations. Preferably, the circumferential indexing (angular spacing) of the cutting edges is irregular to further interrupt generation of resonant vibrations.

### BRIEF DESCRIPTION OF THE DRAWINGS

The nature and mode of operation of the present invention will now be more fully described in the following detailed description of the invention taken with the accompanying drawing figures, in which:

FIG. 1 is a side elevational view of a rotary cutting tool formed in accordance with a first embodiment of the present invention;

FIG. 2 is an end view of a cutting end of the cutting tool of FIG. 1;

FIG. 3 is a schematic development view of the cutting tool of FIG. 1, showing two-dimensional projections of the tool's cutting edges as the tool is rotated about its axis of rotation;

FIG. 4 is a schematic development view of a cutting tool formed in accordance with a second embodiment of the present invention;

FIG. 5 is a schematic development view of a cutting tool formed in accordance with a third embodiment of the present invention; and

FIG. 6 a schematic development view of a cutting tool formed in accordance with a fourth embodiment of the present invention.

### DETAILED DESCRIPTION OF THE INVENTION

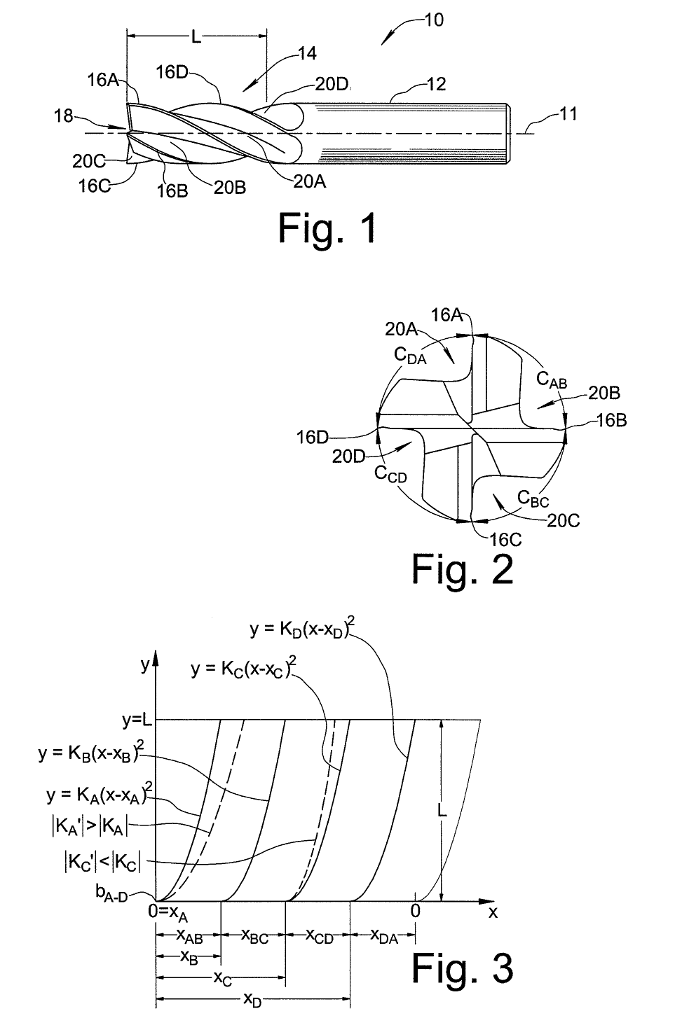

Attention is directed initially to FIGS. 1 and 2, wherein a rotary cutting tool in the form of an end mill is shown and designated generally by the reference numeral 10. End mill 10 generally comprises a shank 12 for receipt by a machine tool spindle or adapter, and a fluted portion 14 for cutting a workpiece. Fluted portion 14 includes a plurality of peripheral cutting edges 16A-16D wrapping around a rotational axis 11 of end mill 10 as the edges proceed in an axial direction along the fluted portion from a cutting end 18 of the end mill toward shank 12. Cutting edges 16A-16D are angularly spaced from one another about rotational axis 11 by a plurality of flutes 20A-20D. Tool 10 is characterized by an effective flute length L which corresponds to the axial length of the peripheral cutting edges which have been relieved to cut.

FIG. 3 is a schematic development view providing a two-dimensional representation of cutting edges 16A-16D in accordance with a first embodiment of the present invention. The two-dimensional representation may be thought of as a plot that would result from inking each cutting edge 16A-16D and rolling end mill 10 along a flat surface to leave a mark where each cutting edge contacts the flat surface. The X-axis represents the circumferential distance as end mill 10 is rotated about axis 11 from a starting position as shown in FIG. 2, while the Y-axis represents distance along the flute length starting at cutting end 18 and moving toward shank 12. In accordance with the present invention, cutting edges 16A-16D are formed such that they each present a quadratic curve when represented in a two-dimensional schematic development view. As may be understood, a helical cutting edge will present a single straight line segment characterized by a single helix angle in such a schematic development view, while a compound helical cutting edge will present a series of connected line segments each characterized by a different helix angle. Thus, in the present invention, cutting edges 16A-16D are not formed as helical or compound helical edges.

In the embodiment of FIG. 3, the four peripheral cutting edges 16A-16D present single parabolic curves in schematic development view according to the respective equations

y=K_{A}*(X−X_{A})²+b_{A} (cutting edge 16A);

y=K_{B}*(X−X_{B})²+b_{B} (cutting edge 16B);

y=K_{C}*(X−X_{C})²+b_{C} (cutting edge 16C); and

y=K_{D}*(X−X_{D})²+b_{D} (cutting edge 16D),

wherein y is a distance along rotational axis 11 of the tool 10 from cutting end 18, K_{A} through K_{D} are respective scaling constants, x is a distance along the circumference of the tool (a circumferential arc length) from the angular origin position corresponding to the point where cutting edge 16A intersects with cutting end 18, X_{A} through X_{D} are respective circumferential arc lengths from the angular origin position to the point where the corresponding cutting edge intersects with cutting end 18 (these may be thought of as indexing offsets), and b_{A} through b_{D} are respective axial offsets. In the embodiment depicted in FIG. 3, the scaling constants are all positive and of equal magnitude, such that the respective curves corresponding to cutting edges 16A-16D have the same shape, which is a convex shape when viewed along a positive y (axial) direction in FIG. 3. Also in the embodiment depicted in FIG. 3, the axial offsets b_{A} through b_{D} are taken to be zero for sake of simplicity, however some or all of these may be non-zero values.

The circumferential indexing of the cutting edges is preferably made according to an irregular angular spacing to further interrupt resonant vibrations. In the plane corresponding to cutting end 18, there is a circumferential distance X_{AB} between cutting edges 16A and 16B, a circumferential distance X_{BC} between cutting edges 16B and 16C, a circumferential distance X_{CD} between cutting edges 16C and 16D, and a circumferential distance X_{DA} between cutting edges 16D and 16A. As will be understood, each of these circumferential distances may be expressed as circumferential index value in units of degrees of angular displacement. For example, X_{AB} may be expressed as an angular circumferential index value C_{AB} as follows:

C_{AB}=(360*X_{AB})/(π*d)

wherein d is the tool diameter. By way of non-limiting example, irregular angular spacing is achieved if a four-fluted tool by using circumferential index values of 91°, 89°, 92°, and 88°.

In the embodiment of FIG. 3, the scaling constants K_{A} through K_{D} are all positive and have the same magnitude. However, the magnitudes of scaling constants K_{A} through K_{D} may be varied to alter the curvatures of cutting edges 16A-16D to disrupt the development of resonant vibrations. This possibility is illustrated by broken or dotted curves in FIG. 3. In the example shown, the absolute value of K_{A}′ is greater than the absolute value of K_{A}, but the absolute value of K_{C}′ is less than the absolute value of K_{C}.

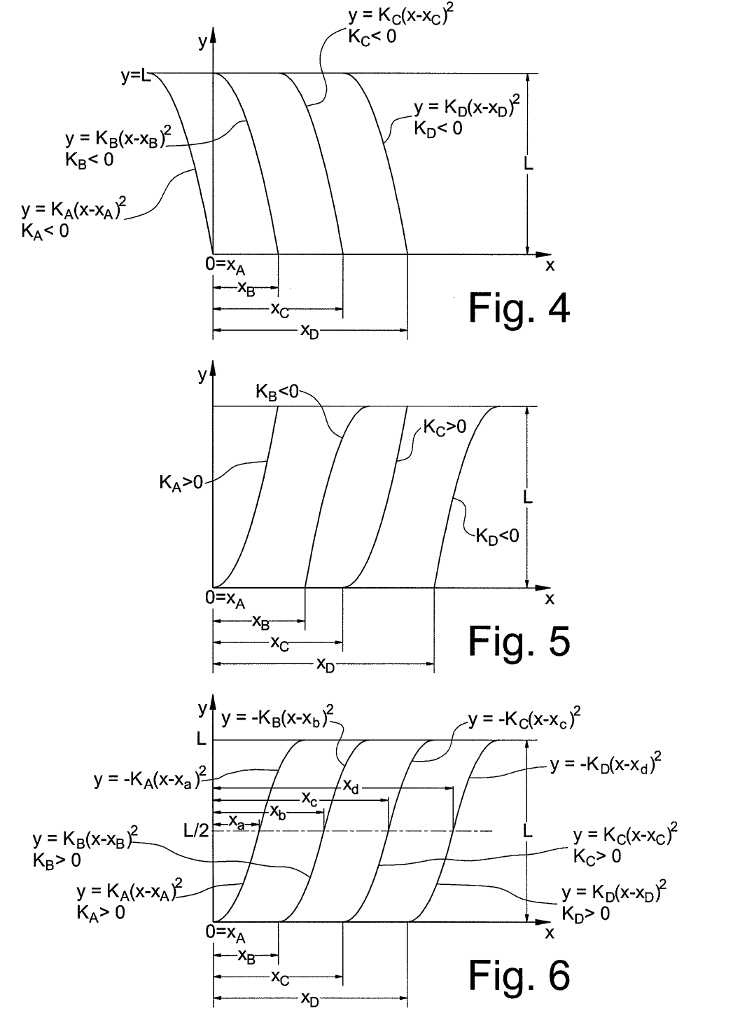

FIG. 4 is a schematic development view similar to that of FIG. 3 illustrating a cutting tool formed in accordance with a second embodiment of the present invention. The embodiment of FIG. 4 differs from that of FIG. 3 in that the scaling constants K_{A} through K_{D} are all negative values, such that the respective curves corresponding to cutting edges 16A-16D have a concave rather than convex shape when viewed along a positive y (axial) direction. Again, the circumferential index values and magnitudes of scaling constants K_{A} through K_{D} may be equal or may vary from cutting edge to cutting edge.

The schematic development view of FIG. 5 illustrates a third embodiment wherein at least one of the cutting edges has a positive scaling constant and at least one other of the cutting edges has a negative scaling constant. In particular, cutting edges 16A and 16C each have a positive cutting scaling constant (K_{A} and K_{C}, respectively), while cutting edges 16B and 16D each have a negative scaling constant (K_{B} and K_{D}, respectively). It is apparent from FIG. 5 that such an embodiment provides circumferential indexing between cutting edges that varies along effective flute length L.

FIG. 6 depicts a compound quadratic curve embodiment wherein each cutting edge is formed so as to present a pair of quadratic curve portions in schematic development view. In the axial range from cutting end 18 (y=0) to the mid-point of the effective flute length (y=L/2), the cutting edges 16A-16D present parabolic curve portions in schematic development view according to the respective equations

y=K_{A}*(X−X_{A})² (cutting edge 16A);

y=K_{B}*(X−X_{B})² (cutting edge 16B);

y=K_{C}*(X−X_{C})² (cutting edge 16C); and

y=K_{D}*(X−X_{D})² (cutting edge 16D),

wherein the respective scaling constants K_{A} through K_{D} are all positive values. In the axial range from y=L/2 to y=L, cutting edges 16A-16D present parabolic curve portions in schematic development view according to the respective equations

y=−K_{A}*(X−Xₐ)² (cutting edge 16A);

y=−K_{B}*(X−X_{b})² (cutting edge 16B);

y=−K_{C}*(X−X_{c})² (cutting edge 16C); and

y=−K_{D}*(X−X_{d})² (cutting edge 16D),

wherein scaling constants K_{A} through K_{D} are multiplied by −1 to switch from a convex curve to a concave curve in two-dimensional representation, and Xₐ through X_{d} are respective indexing offsets in a plane normal to rotational axis 11 at y=L/2. As in the other embodiments, the magnitudes of scaling constants K_{A} through K_{D} may be varied or kept the same from cutting edge to cutting edge. Non-zero axial offset values may also be provided as mentioned in connection with the embodiment of FIG. 3.

While the present invention has been described in terms of a particular type of quadratic curve, namely a parabolic curve, it is also possible to adapt and practice the present invention on the basis of other quadratic curve forms. For example, other conic section forms (circular arcs, ellipsoidal curves, and hyperbolic curves) may be used as a basis for forming the cutting edges. As will be appreciated, the present invention provides a novel design approach to rotary cutting tools that addresses the problem of resonant vibration at high speeds and feeds, to the benefit of workpiece quality.

What is claimed is:

1) A rotary cutting tool comprising:
a) a shank extending along an axis of rotation of the cutting tool;
b) a fluted portion adjacent the shank, the fluted portion having an effective flute length and a plurality of peripheral cutting edges indexed about the axis of rotation, at least one of the plurality of peripheral cutting edges being formed such that a two-dimensional representation of the peripheral cutting edge in schematic development view follows a quadratic curve over the effective flute length.

2) The rotary cutting tool according to claim 1, wherein more than one of the plurality of peripheral cutting edges is formed such that a two-dimensional representation of the peripheral cutting edge in schematic development view follows a quadratic curve over the effective flute length.

3) The rotary cutting tool according to claim 2, wherein at least one of the plurality of peripheral cutting edges is represented by a quadratic curve that differs from a quadratic curve representing at least one other of the plurality of peripheral cutting edges.

4) The rotary cutting tool according to claim 1, wherein at least one of the plurality of cutting edges is represented by a parabolic curve of the form y=Kx²+b wherein K is a scaling constant and b is an axial offset.

5) The rotary cutting tool according to claim 4, wherein each of the plurality of cutting edges is represented by a parabolic curve of the form y=Kx²+b wherein K is a scaling constant and b is an axial offset.

6) The rotary cutting tool according to claim 5, wherein each of the plurality of cutting edges has a positive scaling constant K.

7) The rotary cutting tool according to claim 6, wherein all of the plurality of cutting edges have a scaling constant K of the same magnitude.

8) The rotary cutting tool according to claim 6, wherein at least two of the plurality of cutting edges have respective scaling constants K that differ from each other in magnitude.

9) The rotary cutting tool according to claim 5, wherein each of the plurality of cutting edges has a negative scaling constant K.

10) The rotary cutting tool according to claim 9, wherein all of the plurality of cutting edges have a scaling constant K of the same magnitude.

11) The rotary cutting tool according to claim 9, wherein at least two of the plurality of cutting edges have respective scaling constants K that differ from each other in magnitude.

12) The rotary cutting tool according to claim 1, wherein the quadratic curve is a compound quadratic curve.

13) The rotary cutting tool according to claim 1, wherein the plurality of cutting edges are indexed at irregular angular spacing about the axis of rotation.
